(19) United States
(12) Patent Application Publication
(10) Pub. No.: US 2026/0204555 A1
(43) Pub. Date: Jul. 16, 2026

(54) METHOD FOR PRODUCING NEGATIVE ELECTRODE ACTIVE MATERIAL

(71) Applicant: Panasonic Intellectual Property Management Co., Ltd., Osaka (JP)

(72) Inventors: YOSHIAKI TANAKA, Kyoto (JP); WATARU ISHII, Osaka (JP)

(21) Appl. No.: 19/564,038

(22) Filed: Mar. 11, 2026

Related U.S. Application Data
(63) Continuation of application No. PCT/JP2024/036757, filed on Oct. 16, 2024.

(30) Foreign Application Priority Data
Dec. 5, 2023 (JP) 2023-205703

(51) Int. Cl. H01M 4/485; C01G 31/00

(52) U.S. Cl. CPC H01M 4/485; C01G 31/006; C01P 2002/50; C01P 2002/72; C01P 2006/40

(57) ABSTRACT

A method for producing a negative electrode active material according to the present disclosure includes heat-treating a raw material mixture for the negative electrode active material at a temperature of more than 400° C. and less than 1,100° C. The negative electrode active material has a composition represented by Li_{3+x+α}V₁₋ₓMₓO_{4+α/2}. M is at least one selected from tetravalent semi-metal elements and tetravalent metal elements excluding V. α and x satisfy 0.03<α<1.0 and 0≤x<1.

### BACKGROUND

### 1. Technical Field

The present disclosure relates to a method for producing a negative electrode active material.

### 2. Description of the Related Art

Japanese Unexamined Patent Application Publication No. 2008-77847 discloses a nonaqueous secondary battery using Li₃VO₄ as a negative electrode active material.

International Publication No. 2019/044902 discloses a co-fired all-solid-state battery using a negative electrode active material obtained by doping Li₃VO₄ with an element A and/or an element B. The element A is at least one element selected from the group consisting of Mg, Al, Ga, and Zn. The element B is at least one element selected from the group consisting of Zn, Al, Ga, Si, Ge, P, and Ti.

### SUMMARY

When the lithium vanadium oxides disclosed in Japanese Unexamined Patent Application Publication No. 2008-77847 and International Publication No. 2019/044902 are used as negative electrode active materials, it is difficult to obtain batteries having sufficient capacity.

One non-limiting and exemplary embodiment provides a method for producing a negative electrode active material capable of increasing battery capacity.

In one general aspect, the techniques disclosed here feature a method for producing a negative electrode active material. The method includes heat-treating a raw material mixture for the negative electrode active material at a temperature of more than 400° C. and less than 1,100° C. The negative electrode active material has a composition represented by Li_{3+x+α}V₁₋ₓMₓO_{4+α/2}. M is at least one selected from tetravalent semi-metal elements and tetravalent metal elements excluding V. α and x satisfy 0.03<α<1.0 and 0≤x<1.

According to the present disclosure, higher battery capacity can be achieved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a flowchart of an example of a method for producing a negative electrode active material according to a first embodiment;

FIG. 2 is a flowchart of another example of the method for producing a negative electrode active material according to the first embodiment;

FIG. 3 is a schematic cross-sectional view illustrating a negative electrode material according to a second embodiment;

FIG. 4 is a schematic cross-sectional view illustrating the structure of a battery according to a third embodiment;

FIG. 5 shows X-ray diffraction patterns of negative electrode active materials of Example 1 and Comparative Example 1; and

FIG. 6 is a graph showing the discharge characteristics of a battery of Example 1.

### DETAILED DESCRIPTIONS

Embodiments of the present disclosure will be described below with reference to the drawings. The present disclosure is not limited to the following embodiments.

### First Embodiment

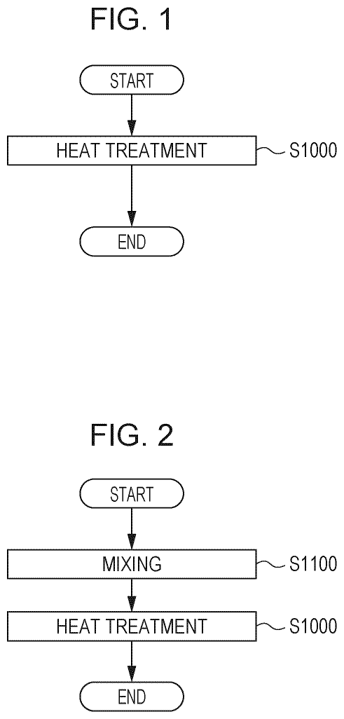

FIG. 1 is a flowchart of an example of a method for producing a negative electrode active material according to a first embodiment. As shown in a step S1000 in FIG. 1, the method for producing a negative electrode active material according to the first embodiment includes heat-treating a raw material mixture for the negative electrode active material at a temperature of more than 400° C. and less than 1,100° C.

An example of the negative electrode active material obtained by the production method of the present embodiment has a composition represented by the composition formula (1): Li_{3+x+α}V₁₋ₓMₓO_{4+α/2}. α and x satisfy 0.03<α<1.0 and 0≤x<1. M is at least one selected from tetravalent semi-metal elements and tetravalent metal elements excluding V. The negative electrode active material produced by the example of the production method of the first embodiment is suitable for increasing battery capacity.

Another example of the negative electrode active material obtained by the production method of the present embodiment contains Li, V, M, and O, and includes both β and γ phases as crystal phases. M is at least one selected from the group consisting of tetravalent semi-metal elements and tetravalent metal elements excluding V. The negative electrode active material produced by the other example of the production method of the present embodiment is also suitable for increasing battery capacity.

The β phase is a crystal phase that can be formed in lithium vanadium oxides and has a crystal structure belonging to the Pmn2₁ space group. Specifically, the crystal structure of the β phase includes tetrahedra composed of LiO₄ (hereinafter referred to simply as “LiO₄ tetrahedra”) and tetrahedra composed of VO₄ (hereinafter referred to simply as “VO₄ tetrahedra”). In the crystal structure of the β phase, the LiO₄ tetrahedra and the VO₄ tetrahedra are oriented in the same direction (the direction of the c-axis, which is one edge of a crystal lattice) with adjacent tetrahedra sharing a corner. The β phase has a high theoretical capacity as a negative electrode active material.

The γ phase is a crystal phase that can be formed in lithium vanadium oxides and has a crystal structure belonging to the Pcmn space group. Specifically, the crystal structure of the γ phase, as with the crystal structure of the β phase, includes LiO₄ tetrahedra and VO₄ tetrahedra. In the γ phase, the LiO₄ tetrahedra and the VO₄ tetrahedra include approximately equal proportions of tetrahedra oriented predominantly in one direction (the direction of the positive c-axis, which is one edge of a crystal lattice) and tetrahedra oriented predominantly in the opposite direction (the direction of the negative c-axis, which is one edge of the crystal lattice). In the crystal structure of the γ phase, a LiO₄ tetrahedron shares a corner and an edge with an adjacent LiO₄ tetrahedron, while a VO₄ tetrahedron shares a corner with an adjacent LiO₄ or VO₄ tetrahedron. The γ phase can be stably formed by substituting some vanadium (V) sites in the crystal lattice with a tetravalent metal other than V.

The ratio of the amount of V in mol to the total amount of V and M in mol (V/(M+V)) is, for example, more than 0% and less than 10%. This configuration facilitates the formation of a mixture of β and γ phases. A high heat treatment temperature during the production of the negative electrode active material facilitates γ phase formation. Selection of raw materials with low melting points as the raw materials for the negative electrode active material facilitates γ phase formation at a lower heat treatment temperature. Therefore, the volume ratio of the β and γ phases can be controlled by appropriately selecting the ratio of the amount of V in mol to the total amount of V and M in mol, the heat treatment temperature during the production of the negative electrode active material, and the melting points of the raw materials for the negative electrode active material.

The volume ratio of the β and γ phases is not limited. Since the volume ratio of the β and γ phases correlates with the results of X-ray diffraction measurements of the negative electrode active material, the results of X-ray diffraction measurements can serve as an indicator of the volume ratio of the β and γ phases. It should be noted that the intensity of a diffraction peak represents the height of the diffraction peak and does not represent the area or volume of the β or γ phase. For example, the ratio of the intensity of a diffraction peak assigned to the (101) plane of the B phase to the intensity of a diffraction peak assigned to the (011) plane of the γ phase in the X-ray diffraction pattern using Cu-Kα radiation as the source is greater than or equal to 0.1 and smaller than or equal to 10.0. The ratio of these diffraction peak intensities may be greater than or equal to 0.1 and smaller than or equal to 7.0. When the ratio of the diffraction peak intensities falls within the above ranges, a battery using such a negative electrode active material can exhibit good charge-discharge characteristics.

The diffraction peak assigned to the (101) plane of the β phase appears at 22.7°+0.2° due to the change in the lattice constant of the B phase caused by doping with the element M. Similarly, the diffraction peak assigned to the (011) plane of the γ phase appears at 22.4°+0.2° due to the change in the lattice constant of the γ phase caused by doping with the element M. Accordingly, instead of the above condition regarding the ratio of the diffraction peak intensities, the ratio of the intensity of the diffraction peak appearing at a diffraction angle 2θ of 22.7°+0.2° to the intensity of the diffraction peak appearing at a diffraction angle 2θ of 22.4°+0.2° in the X-ray diffraction pattern using Cu-Kα radiation as the source may be greater than or equal to 0.1 and smaller than or equal to 10.0. When two diffraction peaks are present within a region where the diffraction angles 2θ of “22.4°+0.2°” and “22.7°+0.2°” overlap, that is, a region of “more than or equal to 22.5° and less than or equal to 22.6°”, the correspondence between each diffraction peak and its crystal plane is determined by considering the relative intensity relationships among other peaks from the β and γ phases. Furthermore, the diffraction peak assigned to the (011) plane of the γ phase tends to appear at 22.4°=0.1°, and the diffraction peak assigned to the (101) plane of the β phase tends to appear at 22.7°=0.1°. Accordingly, the ratio of the intensity of the diffraction peak appearing at a diffraction angle 2θ of 22.7°+0.1° to the intensity of the diffraction peak appearing at a diffraction angle 2θ of 22.4°+0.1° in the X-ray diffraction pattern using Cu-Kα radiation as the source may be greater than or equal to 0.1 and smaller than or equal to 10.0. The ratio of these diffraction peak intensities may be greater than or equal to 0.1 and smaller than or equal to 7.0.

The raw material mixture is prepared such that the desired composition can be achieved. The raw material mixture contains, for example, a Li raw material, a V raw material, and an M raw material. The raw material mixture may be a mixture containing a Li raw material containing Li and O, a V raw material containing V and O, and an M raw material containing M and O.

Examples of the Li raw material include hydroxides of Li, oxides of Li, carbonates of Li, nitrates of Li, nitrides of Li, and organic salts of Li. One or more materials selected from these examples can be used as Li raw materials. The Li raw material may contain at least one selected from the group consisting of Li₂CO₃, Li₂O, LiOH, and LiOH hydrate.

Examples of the V raw material include hydroxides of V, oxides of V, carbonates of V, nitrates of V, nitrides of V, and organic salts of V. One or more materials selected from these examples can be used as V raw materials. The V raw material may contain at least one selected from the group consisting of V₂O₅ and NH₄VO₃.

Examples of the M raw material include hydroxides of M, oxides of M, carbonates of M, nitrates of M, nitrides of M, and organic salts of M. One or more materials selected from these examples can be used as M raw materials. In the cases where M is Ti, the M raw material may contain at least one selected from the group consisting of TiO₂ and Ti₂O₃.

The heat treatment temperature may be changed according to the type of raw material. The heat treatment temperature of the raw material mixture may be lowered when the raw materials with low melting points are used.

The Li content in the raw material mixture may decrease due to evaporation during the heat treatment of the step S1000. This means that the composition ratio of Li in the raw material mixture may be inconsistent with the composition ratio of Li in the negative electrode active material. Therefore, the contents of Li, V, M, and O in the raw material mixture are adjusted so that “x” and “α” in the composition formula (1) fall within the respective desired ranges. The Li content in the negative electrode active material can be determined by composition analysis using methods such as ICP optical emission spectrometry, atomic absorption spectrometry, and electron probe microanalysis (EPMA).

The heat treatment temperature of the raw material mixture may be higher than or equal to 450° C. and lower than or equal to 1,000° C. This configuration enables the negative electrode active material of the first embodiment to further increase battery capacity.

The heat treatment temperature of the raw material mixture may be higher than or equal to 500° C. and lower than or equal to 900° C. This configuration enables the negative electrode active material produced by the production method of the first embodiment to further increase battery capacity.

The heat treatment time for the raw material mixture may be longer than or equal to 5 hours, during which the heat treatment temperature is maintained at higher than 400° C. and lower than 1,100° C. This configuration facilitates appropriate heat treatment of the raw material mixture.

The heat treatment time for the raw material mixture may be longer than or equal to 10 hours or may be longer than or equal to 15 hours. The heat treatment time for the raw material mixture may be shorter than or equal to 5 hours. This configuration facilitates appropriate heat treatment of the raw material mixture.

The heating rate in the step of the raw material mixture is, for example, greater than or equal to 1° C./min and smaller than or equal to 10° C./min. The cooling rate in the step of the raw material mixture is, for example, greater than or equal to 1° C./min and smaller than or equal to 10° C./min.

The raw material mixture may be heat-treated in ambient air, dry air, a vacuum, or an inert gas atmosphere. Examples of the inert gas include helium gas, nitrogen gas, and argon gas. The raw material mixture may be heat-treated in a reducing gas atmosphere. Examples of the reducing gas include ammonia gas, methane gas, and hydrogen sulfide gas.

The raw material mixture may be placed in an aluminum crucible and heat-treated therein.

FIG. 2 is a flowchart of another example of the method for producing a negative electrode active material according to the first embodiment. As shown in FIG. 2, the method for producing a negative electrode active material according to the first embodiment may include a step S1100 of mixing raw materials for the negative electrode active material prior to the step S1000 of heat-treating a raw material mixture for the negative electrode active material. Mixing the raw materials for the negative electrode active material means mixing a Li raw material, a V raw material, and an M raw material to obtain a raw material mixture.

In the mixing of the step S1100, the Li raw material, the V raw material, and the M raw material may be weighed and mixed such that the desired molar ratio can be achieved. The method for mixing the raw materials may be a method using a known mixing device. In this case, a powder form of raw material mixture may be heat-treated in the heat treatment of the step S1000. Examples of the mixing device include mortars, blenders, and ball mills.

The raw materials for the negative electrode active material may be in crystal, lump, flake, powder, or other forms. A powder form of raw material mixture obtained in the mixing of the step S1100 may be molded into pellets by uniaxial pressing.

The heat treatment of the step S1000 shown in FIGS. 1 and 2 may be performed in multiple rounds. Specifically, the negative electrode active material obtained by the first round of heat treatment is pulverized and mixed, and then heat-treated again. In some cases, such multiple rounds of heat treatment can enhance the crystallinity of the negative electrode active material. For example, the step S1000 of heat-treating the raw material mixture for the negative electrode active material is performed in two rounds. In this case, the heat treatment temperature in the first round may be lower than the heat treatment temperature in the second round.

M may be Ti. The following describes the cases where M is Ti. The raw material mixture to be heat-treated in the step S1000 may contain at least one selected from the group consisting of Li₂CO₃, Li₂O, LiOH, and LiOH hydrate, at least one selected from the group consisting of V₂O₅ and NH₄VO₃, and at least one selected from the group consisting of TiO₂ and Ti₂O₃.

In the cases where M is Ti, the negative electrode active material has a composition represented by the composition formula: Li_{3+x+α}V₁₋ₓTiₓO_{4+α/2}. In such a negative electrode active material, x is assumed to be 0.05 in the mixing of the raw materials. First, the raw material powders are prepared on the assumption that a is 0. For example, Li₂CO₃, V₂O₅, and TiO₂ are prepared at a molar ratio of Li₂CO₃:V₂O₅:TiO₂=(3.05/2):(0.95/2):0.05. To the raw material powders prepared at such a molar ratio, a Li source material, for example, Li₂CO₃, is further added according to the value of α in the desired composition, and the raw material powders are mixed. The excess amount of the Li source to be mixed in excess can be appropriately determined according to, for example, the value of α in the desired composition and the type of material used as the Li source. The Li source may be prepared with a 0.5 to 40 wt % excess or a 1 to 30 wt % excess relative to the amount of the Li source at the molar ratio determined on the assumption that a is 0.

As the Li source, lithium hydroxide or a hydrate thereof may be used instead of Li₂CO₃.

The raw material powder mixture is heat-treated to obtain a reaction product. The atmosphere during the heat treatment may be an ambient air atmosphere or an inert gas atmosphere. The inert gas atmosphere is, for example, an argon atmosphere or a nitrogen atmosphere. The atmosphere during the heat treatment may be a reducing gas atmosphere. The reducing gas atmosphere is, for example, an ammonia atmosphere, a methane atmosphere, or a hydrogen sulfide atmosphere.

The negative electrode active material can also be obtained by reactions of individual materials in the raw material powder mixture in a mixing device such as a planetary ball mill in a mechanochemical manner (using a mechanochemical milling method). These methods produce a negative electrode active material having a composition represented by the composition formula (1): Li_{3+x+α}V₁₋ₓTiₓO_{4+α/2}.

The negative electrode active material produced by the production method of the first embodiment has good electronic conductivity and thus is suitable for increasing battery capacity. An example of the battery is a solid-state battery. The solid-state battery may be a primary battery or a secondary battery. The solid-state battery may be an all-solid-state battery.

When α in the composition formula (1) satisfies 0.03<α<1.0, a battery using the negative electrode active material of the first embodiment exhibits higher capacity. This is because the intercalation and deintercalation of Li into and from the negative electrode active material of the first embodiment are facilitated.

The Li and O in amounts represented by α in the composition formula (1) may be incorporated into the β and/or γ crystal phase of the negative electrode active material or may be present as a crystal phase other than the β and γ phases. This configuration further increases the capacity of a battery using the negative electrode active material. It should be noted that none of the negative electrode active materials disclosed in Japanese Unexamined Patent Application Publication No. 2008-77847 and International Publication No. 2019/044902 contains Li or O in an amount corresponding to the amount represented by “α”.

α in the composition formula (1) may satisfy 0.04≤α≤0.95. This configuration enables the negative electrode active material of the first embodiment to further increase battery capacity.

α in the composition formula (1) may satisfy 0.06≤α≤0.93. This configuration enables the negative electrode active material of the first embodiment to further increase battery capacity.

α in the composition formula (1) may satisfy 0.1≤α≤0.6. This configuration enables the negative electrode active material of the first embodiment to further increase battery capacity.

α in the composition formula (1) may satisfy 0.14≤α≤0.57. This configuration enables the negative electrode active material of the first embodiment to further increase battery capacity.

The upper and lower limits of the range of α in the composition formula (1) may be defined using any combination of values selected from more than 0.03 (i.e., 0.03<α), 0.04, 0.06, 0.1, 0.14, 0.24, 0.25, 0.32, 0.57, 0.6, 0.93, 0.95, and less than 1.0 (i.e., α<1.0).

In the composition formula (1), x may satisfy 0<x≤0.1. This configuration enables the negative electrode active material of the first embodiment to further increase battery capacity.

In the composition formula (1), x may satisfy 0<x≤1.0. This configuration enables the negative electrode active material of the first embodiment to further increase battery capacity.

The upper and lower limits of the range of x in the composition formula (1) may be defined using any combination of values selected from more than 0 (i.e., 0<x), 0.05, 0.1, and less than 1.0 (i.e., x<1.0).

When x in the composition formula (1) falls within the above ranges, the intercalation and deintercalation of Li into and from the negative electrode active material of the first embodiment are further facilitated. Thus, the negative electrode active material of the first embodiment can further increase battery capacity as described above.

α and x in the composition formula (1) may satisfy 0.07≤α≤0.21 and 0.01≤x≤0.19. This configuration enables the negative electrode active material of the first embodiment to further increase battery capacity.

As described above, M is at least one selected from tetravalent semi-metal elements and tetravalent metal elements excluding V. The tetravalent metal elements and tetravalent semi-metal elements may be at least one selected from the group consisting of Ti, Zr, Si, Ge, and Sn.

In the composition formula (1), M may include Ti. This configuration enables the negative electrode active material of the first embodiment to further increase battery capacity. M may be Ti. This configuration enables the negative electrode active material of the first embodiment to further increase battery capacity.

The shape of the negative electrode active material of the first embodiment is not limited. Examples of the shape are needle-like, spherical, and ellipsoidal shapes. The negative electrode active material of the first embodiment may be in the form of particles. The negative electrode active material of the first embodiment may be formed into pellets or plates.

When the negative electrode active material of the first embodiment is in the form of particles (e.g., spherical), the particles of the negative electrode active material may have a median size of more than or equal to 0.1 μm and less than or equal to 100 μm or may have a median size of more than or equal to 0.5 μm and less than or equal to 10 μm. This allows for good dispersion of the negative electrode active material of the first embodiment and other materials. Other materials are, for example, solid electrolyte materials.

The median size of a particle refers to a particle size (d50) corresponding to the 50% cumulative volume in a volume-based particle size distribution. The volume-based particle size distribution can be measured using a laser diffraction analyzer or an image analyzer.

### Second Embodiment

A second embodiment will be described below. The descriptions already provided in the first embodiment are omitted where appropriate.

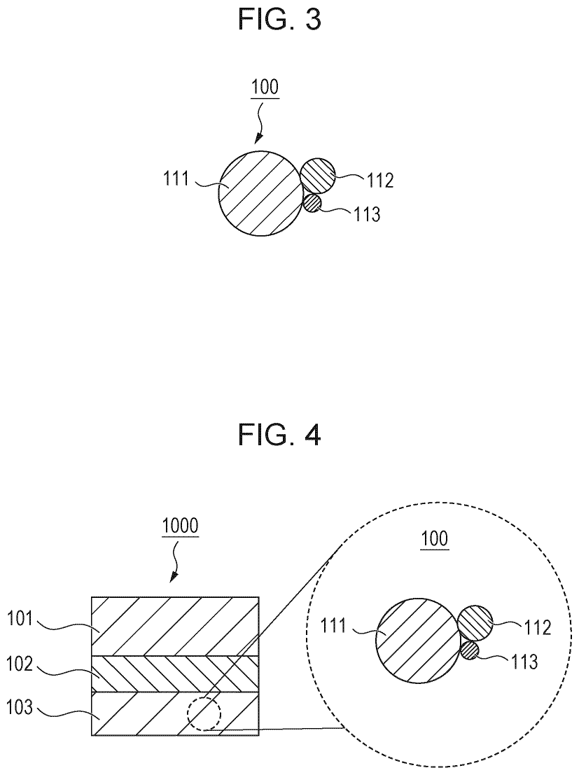

FIG. 3 illustrates a negative electrode material 100 according to the second embodiment. The negative electrode material 100 contains a negative electrode active material 111 and a solid electrolyte 112. The negative electrode material 100 may contain a conductive additive 113 in order to enhance electronic conductivity. The negative electrode active material 111, the solid electrolyte 112, and the conductive additive 113 are each in the form of particles, for example. The negative electrode active material 111 contains the negative electrode active material of the first embodiment. The negative electrode active material of the first embodiment is suitable for increasing battery capacity.

The negative electrode active material 111 may contain the negative electrode active material of the first embodiment as a main component. The phrase “contain the negative electrode active material of the first embodiment as a main component” means that the negative electrode active material of the first embodiment is the component having the highest mass ratio. The negative electrode active material 111 may consist of the negative electrode active material of the first embodiment.

The conductive additive 113 may be provided so as to cover at least part of the negative electrode active material 111. This can provide a larger contact area between the conductive additive 113 and the negative electrode active material 111. As a result, when the negative electrode material 100 is used in batteries, the batteries have reduced resistance and can exhibit higher output.

The ratio of the volume of the conductive additive 113 to the total volume of the negative electrode active material 111 and the conductive additive 113 may be greater than or equal to 0.01 and smaller than or equal to 0.4.

Since the negative electrode material 100 according to the second embodiment contains the negative electrode active material of the first embodiment, the use of the negative electrode material 100 according to the second embodiment allows the production of negative electrodes suitable for increasing battery capacity.

### Third Embodiment

A third embodiment will be described below. The descriptions already provided in the first and second embodiments are omitted where appropriate.

FIG. 4 illustrates a battery 1000 of an example of the third embodiment. The battery 1000 includes a positive electrode 101, an electrolyte layer 102, and a negative electrode 103. The electrolyte layer 102 is provided between the positive electrode 101 and the negative electrode 103.

The positive electrode 101 contains a positive electrode active material and a solid electrolyte.

The electrolyte layer 102 contains an electrolyte material. The electrolyte material is, for example, a solid electrolyte material.

The negative electrode 103 contains a negative electrode active material 111 and a solid electrolyte 112.

The negative electrode active material 111 is in the form of particles containing the negative electrode active material of the first embodiment. The negative electrode active material 111 may be in the form of particles containing the negative electrode active material of the first embodiment as a main component. The phrase “particles containing the negative electrode active material of the first embodiment as a main component” means particles containing the negative electrode active material of the first embodiment as the component having the highest mass ratio. The negative electrode active material 111 may be in the form of particles consisting of the negative electrode active material of the first embodiment.

The negative electrode active material 111 may have a median size of more than or equal to 0.1 μm and less than or equal to 100 μm. When the negative electrode active material 111 has a median size of more than or equal to 0.1 μm, the negative electrode active material 111 and the solid electrolyte 112 have good dispersibility in the negative electrode 103. This improves the charge-discharge characteristics of the battery 1000. When the negative electrode active material 111 has a median size of less than or equal to 100 μm, the lithium diffusion rate in the negative electrode active material 111 increases. This enables the battery 1000 to operate with high output.

The negative electrode active material 111 may have a greater median size than the solid electrolyte 112. This allows for good dispersion of the negative electrode active material 111 and the solid electrolyte 112.

In order to increase the energy density and output of the battery 1000, the ratio of the volume of the negative electrode active material 111 to the total volume of the negative electrode active material 111 and the solid electrolyte 112 in the negative electrode 103 may be greater than or equal to 0.30 and smaller than or equal to 0.95.

In order to increase the energy density and output of the battery 1000, the negative electrode 103 may have a thickness of more than or equal to 10 μm and less than or equal to 500 μm.

The solid electrolyte 112 contained in the negative electrode 103 may be a sulfide solid electrolyte, a halide solid electrolyte, an oxide solid electrolyte, or a polymeric solid electrolyte.

In the present disclosure, the term “sulfide solid electrolyte” refers to a solid electrolyte containing sulfur. The term “oxide solid electrolyte” refers to a solid electrolyte containing oxygen. The oxide solid electrolyte may contain an anion other than oxygen (excluding a sulfur anion and a halogen anion). The term “halide solid electrolyte” refers to a solid electrolyte that contains a halogen element and does not contain sulfur. The halide solid electrolyte may contain not only a halogen element, but also oxygen.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

An example of the halide solid electrolyte is a compound having a composition represented by the composition formula: LiₐMe_{b}Y_{c}X₆. Here, a, b, and c satisfy a+mb+3c=6 and c>0. Me is at least one selected from the group consisting of semi-metal elements and metal elements other than Li and Y. X is at least one element selected from the group consisting of F, Cl, Br, and I. m represents the valence of Me.

The term “semi-metal element” refers to B, Si, Ge, As, Sb, and Te. The term “metal element” refers to all elements included in Groups 1 to 12 of the periodic table (excluding H) and all elements included in Groups 13 to 16 of the periodic table (excluding B, Si, Ge, As, Sb, Te, C, N, P, O, S, and Se).

In order to enhance the ionic conductivity of the halide solid electrolyte, Me may be at least one element selected from the group consisting of Mg, Ca, Sr, Ba, Zn, Sc, Al, Ga, Bi, Zr, Hf, Ti, Sn, Ta, and Nb.

Another example of the halide solid electrolyte is a compound having a composition represented by the composition formula: Li_{α}M_{β}O_{γ}X_{δ}. Here, α, β, γ, and δ are values greater than 0. M is at least one element selected from the group consisting of semi-metal elements and metal elements other than Li. X is at least one element selected from the group consisting of Cl, Br, and I. In the composition of the compound, α, β, γ, and δ satisfy 0.9≤α≤1.2, β=1.0, 1.0≤γ≤1.3, and 3.6≤δ≤4.0.

Examples of the oxide solid electrolyte are:
(i) NASICON-type solid electrolytes such as LiTi₂(PO₄)₃ or element-substituted compounds thereof,
(ii) perovskite-type solid electrolytes such as (LaLi)TiO₃,
(iii) LISICON-type solid electrolytes such as Li₁₄ZnGe₄O₁₆, Li₄SiO₄, LiGeO₄, or element-substituted compounds thereof,
(iv) garnet-type solid electrolytes such as Li₇La₃Zr₂O₁₂ or element-substituted compounds thereof, and
(v) Li₃PO₄ or N-substituted compounds thereof.

Examples of the polymeric solid electrolyte are polymer compounds and lithium salt compounds. The polymer compounds may have an ethylene oxide structure. The polymer compounds having an ethylene oxide structure can incorporate a large amount of a lithium salt and thus have higher ionic conductivity. The polymeric solid electrolyte may be a composite compound of polyethylene oxide and a lithium salt. An example of such a polymeric solid electrolyte is lithium bis(trifluoromethanesulfonyl)imide.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these examples may be used singly. A mixture of two or more lithium salts selected from these examples may be used.

The positive electrode 101 contains a material capable of storing and releasing metal ions such as lithium ions. The positive electrode 101 contains, for example, a positive electrode active material (e.g., particles of a positive electrode active material).

Examples of the positive electrode active material are lithium-containing transition metal oxides, transition metal fluorides, polyanion materials, fluorinated polyanion materials, transition metal sulfides, transition metal oxysulfides, and transition metal oxynitrides. Examples of lithium-containing transition metal oxides are Li(Ni,Co,Al)O₂, Li(Ni,Co,Mn)O₂, and LiCoO₂.

In the present disclosure, “(A,B,C)” means “at least one selected from the group consisting of A, B, and C”.

In view of the cost and safety of the battery 1000, lithium phosphate may be used as the positive electrode active material.

The positive electrode active material may have a median size of more than or equal to 0.1 μm and less than or equal to 100 μm. When the positive electrode active material has a median size of more than or equal to 0.1 μm, the positive electrode active material and the solid electrolyte have good dispersibility in the positive electrode 101. This improves the charge-discharge characteristics of the battery 1000. When the positive electrode active material has a median size of less than or equal to 100 μm, the lithium diffusion rate in the positive electrode active material increases. This enables the battery 1000 to operate with high output.

The positive electrode active material may have a greater median size than the solid electrolyte. This allows for good dispersion of the positive electrode active material and the solid electrolyte.

In order to increase the energy density and output of the battery 1000, the ratio of the volume of the positive electrode active material to the total volume of the positive electrode active material and the solid electrolyte in the positive electrode 101 may be greater than or equal to 0.30 and smaller than or equal to 0.95.

The positive electrode active material may have a coating layer formed on the surface thereof. This can reduce the increase in the reaction overpotential in batteries. Examples of a coating material contained in the coating layer are sulfide solid electrolytes, oxide solid electrolytes, polymeric solid electrolytes, and halide solid electrolytes.

The coating material may be a halide solid electrolyte material or an oxide solid electrolyte material. The halide solid electrolyte material may contain F. This enhances the stability of the coating material at high potential. As a result, the battery 1000 exhibits high charge-discharge efficiency. The oxide solid electrolyte may be lithium niobate or a polyanion material, both of which are stable even at high potential. This configuration enables high charge-discharge efficiency in the battery 1000.

In order to increase the energy density and output of the battery 1000, the positive electrode 101 may have a thickness of more than or equal to 10 μm and less than or equal to 500 μm.

The solid electrolyte contained in the positive electrode 101 may be a sulfide solid electrolyte, a halide solid electrolyte, an oxide solid electrolyte, a polymeric solid electrolyte, or an organic polymeric solid electrolyte.

The electrolyte layer 102 contains an electrolyte material. The electrolyte material is, for example, a solid electrolyte material. The electrolyte layer 102 may be an electrolyte layer composed of a solid electrolyte layer. The solid electrolyte material contained in the electrolyte layer 102 may be a sulfide solid electrolyte, a halide solid electrolyte, or a polymeric solid electrolyte.

The electrolyte layer 102 may have a thickness of more than or equal to 1 μm and less than or equal to 100 μm. When the electrolyte layer 102 has a thickness of more than or equal to 1 μm, the positive electrode 101 and negative electrode 103 are less prone to short-circuiting. When the electrolyte layer 102 has a thickness of less than or equal to 100 μm, the battery 1000 can operate with high output.

At least one selected from the group consisting of the positive electrode 101, the electrolyte layer 102, and the negative electrode 103 may contain a nonaqueous electrolyte solution, a gel electrolyte, or an ionic liquid in order to facilitate the transfer of lithium ions and improve the output characteristics of the battery.

The nonaqueous electrolyte solution contains a nonaqueous solvent and a lithium salt dissolved in the nonaqueous solvent. Examples of the nonaqueous solvent are cyclic carbonate solvents, chain carbonate solvents, cyclic ether solvents, chain ether solvents, cyclic ester solvents, chain ester solvents, and fluorinated solvents. Examples of cyclic carbonate solvents are ethylene carbonate, propylene carbonate, and butylene carbonate. Examples of chain carbonate solvents are dimethyl carbonate, ethyl methyl carbonate, and diethyl carbonate. Examples of cyclic ether solvents are tetrahydrofuran, 1,4-dioxane, and 1,3-dioxolane. Examples of chain ether solvents are 1,2-dimethoxyethane and 1,2-diethoxyethane. An example of a cyclic ester solvent is γ-butyrolactone. An example of a chain ester solvent is methyl acetate.

Examples of fluorinated solvents are fluoroethylene carbonate, methyl fluoropropionate, fluorobenzene, fluoroethyl methyl carbonate, and fluorodimethylene carbonate. One nonaqueous solvent selected from these examples may be used singly. A mixture of two or more nonaqueous solvents selected from these examples may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these examples may be used singly. A mixture of two or more lithium salts selected from these examples may be used. The concentration of the lithium salt is in the range of, for example, more than or equal to 0.5 mol/L and less than or equal to 2 mol/L.

As the gel electrolyte, polymer materials impregnated with a nonaqueous electrolyte solution can be used. Examples of polymer materials include polyethylene oxide, polyacrylonitrile, polyvinylidene fluoride, polymethyl methacrylate, and polymers containing ethylene oxide linkages.

Examples of cations in the ionic liquid are:
(i) aliphatic chain quaternary salts such as tetraalkylammonium and tetraalkylphosphonium,
(ii) aliphatic cyclic ammonium such as pyrrolidinium, morpholinium, imidazolinium, tetrahydropyrimidinium, piperadinium, and piperidinium, and
(iii) nitrogen-containing heterocyclic aromatic cations such as pyridinium and imidazolium.

Examples of anions in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SF)(SO₂C₄F₉)⁻, and C(SO₂CF₃)₃⁻.

The ionic liquid may contain a lithium salt.

At least one selected from the group consisting of the positive electrode 101, the electrolyte layer 102, and the negative electrode 103 may contain a binder in order to enhance the adhesion between particles.

Examples of the binder are polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethyl cellulose. A copolymer may also be used as the binder. Examples of such a binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above examples may be used as the binder.

The negative electrode 103 may contain a conductive additive 113 in order to enhance electronic conductivity.

Examples of the conductive additive 113 are:
(i) graphites such as natural graphite and artificial graphite,
(ii) carbon blacks such as acetylene black and Ketjenblack,
(iii) conductive fibers such as carbon fibers and metal fibers,
(iv) carbon fluorides,
(v) metal powders such as aluminum,
(vi) conductive whiskers such as zinc oxide and potassium titanate,
(vii) conductive metal oxides such as titanium oxide, and
(viii) conductive polymer compounds such as polyaniline, polypyrrole, and polythiophene.

For cost reduction, the conductive additive (i) or (ii) may be used.

The positive electrode 101 may contain not only the positive electrode active material, but also a conductive additive. Examples of the material for the conductive additive are as described above.

The conductive additive 113 in the negative electrode 103 may cover at least part of the surface of the negative electrode active material 111. This provides a larger contact area between the conductive additive 113 and the negative electrode active material 111. As a result, the battery has reduced resistance and can exhibit higher output. The conductive additive in the positive electrode 101 may also cover at least part of the surface of the positive electrode active material.

The ratio of the volume of the conductive additive 113 to the total volume of the negative electrode active material 111 and the conductive additive 113 in the negative electrode 103 may be greater than or equal to 0.01 and smaller than or equal to 0.4. The ratio of the volume of the conductive additive to the total volume of the positive electrode active material and the conductive additive in the positive electrode 101 may also be greater than or equal to 0.01 and smaller than or equal to 0.4.

The negative electrode material 100 shown in FIG. 3 may be contained in the negative electrode 103. The negative electrode active material 111 may have a coating layer formed on the surface thereof to prevent the solid electrolyte 112 from reacting with the negative electrode active material 111. This configuration enables high charge-discharge efficiency in the battery 1000.

Examples of a coating material contained in the coating layer are sulfide solid electrolytes, oxide solid electrolytes, polymeric solid electrolytes, and halide solid electrolytes.

An example of a sulfide solid electrolyte is Li₂S—P₂S₅. An example of an oxide solid electrolyte is lithium triphosphate. An example of a polymeric solid electrolyte is a composite compound of polyethylene oxide and a lithium salt. An example of such a polymeric solid electrolyte is lithium bis(trifluoromethanesulfonyl)imide.

Examples of the shape of the battery according to the third embodiment are coin, cylindrical, prismatic, sheet, button, pouch, and stacked types.

The battery according to the third embodiment may be produced by, for example, preparing materials for forming a positive electrode, materials for forming an electrolyte layer, and materials for forming a negative electrode, and then fabricating a layered body in which the positive electrode, the electrolyte layer, and the negative electrode are stacked in this order using a known method.

### OTHER EMBODIMENTS

### Supplementary Description

The description of the above embodiments discloses the following techniques.

### Technique 1

A method for producing a negative electrode active material, the method including:
heat-treating a raw material mixture for the negative electrode active material at a temperature of more than 400° C. and less than 1,100° C.,
wherein the negative electrode active material has a composition represented by Li_{3+x+α}V₁₋ₓMₓO_{4+α/2},
wherein M is at least one selected from tetravalent semi-metal elements and tetravalent metal elements excluding V, and
wherein α and x satisfy 0.03<α<1.0 and 0≤x<1.

According to the present disclosure, when the negative electrode active material obtained by the production method is used in batteries, higher battery capacity is achieved.

### Technique 2

The method for producing a negative electrode active material according to technique 1, wherein α and x satisfy 0.07≤α≤0.21 and 0.01≤x≤0.19. This configuration leads to even higher battery capacity when the negative electrode active material obtained by the production method is used in batteries.

### Technique 3

A method for producing a negative electrode active material, the method including:
heat-treating a raw material mixture for the negative electrode active material at a temperature of more than 400° C. and less than 1,100° C.,
wherein the negative electrode active material contains Li, V, M, and O,
wherein M is at least one selected from the group consisting of tetravalent semi-metal elements and tetravalent metal elements excluding V, and
wherein the negative electrode active material includes both β and γ phases as crystal phases.

According to the present disclosure, when the negative electrode active material obtained by the production method is used in batteries, higher battery capacity is achieved. Furthermore, since the negative electrode active material obtained by the production method includes both β and γ phases, when the negative electrode active material obtained by the production method is used in batteries, both high battery capacity and high durability can be achieved.

### Technique 4

The method for producing a negative electrode active material according to any one of techniques 1 to 3, wherein the raw material mixture is heat-treated at a temperature of more than or equal to 450° C. and less than or equal to 1,000° C. This configuration leads to even higher battery capacity when the negative electrode active material obtained by the production method is used in batteries.

### Technique 5

The method for producing a negative electrode active material according to any one of techniques 1 to 4, wherein the raw material mixture is heat-treated at a temperature of more than or equal to 500° C. and less than or equal to 900° C. This configuration leads to even higher battery capacity when the negative electrode active material obtained by the production method is used in batteries.

### Technique 6

The method for producing a negative electrode active material according to any one of techniques 1 to 5, wherein the raw material mixture is a mixture containing a Li raw material containing Li and O, a V raw material containing V and O, and an M raw material containing M and O. This configuration makes it possible to easily obtain the raw material mixture at low cost.

### Technique 7

The method for producing a negative electrode active material according to any one of techniques 1 to 6, wherein M includes Ti. This configuration leads to even higher battery capacity when the negative electrode active material obtained by the production method is used in batteries.

### Technique 8

The method for producing a negative electrode active material according to any one of techniques 1 to 7, wherein the raw material mixture is heat-treated for more than or equal to 5 hours. This configuration facilitates appropriate heat treatment of the raw material mixture.

### EXAMPLES

The present disclosure will be described in detail below using examples and comparative examples. The method for producing a negative electrode active material and the method for producing a battery according to the present disclosure are not limited to the following examples.

### Example 1

The negative electrode active material of Example 1 was produced as follows. First, Li₂CO₃ (manufactured by Kojundo Chemical Laboratory Co., Ltd., purity: 99.9%), V₂O₅ (manufactured by Kojundo Chemical Laboratory Co., Ltd., purity: 99.9%), and TiO₂ (manufactured by Kojundo Chemical Laboratory Co., Ltd., purity: 99.9%) were prepared at a molar ratio of Li₂CO₃:V₂O₅:TiO₂=1.525:0.475:0.05. Li₂CO₃ was added with a 3 wt % excess relative to the weight corresponding to Li₂CO₃ at the above molar ratio. These raw material powders were mixed in a mortar to obtain a powder mixture. The powder mixture was subjected to preliminary heat treatment at 600° C. in ambient air for 3 hours. The powder subjected to the preliminary heat treatment was subjected to main heat treatment at 900° C. in ambient air for 15 hours. Thus, the negative electrode active material of Example 1 was produced. Here, the heating was performed at an average rate of 5° C./min, and the cooling was performed at an average rate of 3° C./min.

### Example 2

Li₂CO₃, V₂O₅, and TiO₂ were prepared at a molar ratio of Li₂CO₃:V₂O₅:TiO₂=1.525:0.475:0.05. Li₂CO₃ was added with a 10 wt % excess relative to the weight corresponding to Li₂CO₃ at the above molar ratio. The heat treatment conditions were the same as in Example 1, except that the temperature for the main heat treatment was changed to 940° C. Thus, the negative electrode active material of Example 2 was produced.

### Example 3

The negative electrode active material of Example 3 was produced in the same manner as in Example 2, except that the temperature and time for the main heat treatment were changed to 985° C. and 5 hours, respectively.

### Example 4

The negative electrode active material of Example 4 was produced in the same manner as in Example 2, except that the temperature for the main heat treatment was changed to 800° C. and that the excess amount of Li₂CO₃ was changed to 3 wt %.

### Example 5

The negative electrode active material of Example 5 was produced in the same manner as in Example 2, except that the temperature for the main heat treatment was changed to 700° C. and that the excess amount of Li₂CO₃ was changed to 3 wt %.

### Example 6

The negative electrode active material of Example 6 was produced in the same manner as in Example 2, except that the temperature for the main heat treatment was changed to 600° C. and that the excess amount of Li₂CO₃ was changed to 3 wt %.

### Example 7

The Li raw material was changed from Li₂CO₃ to LiOH, and LiOH, V₂O₅, and TiO₂ were prepared at a molar ratio of LiOH:V₂O₅:TiO₂=3.05:0.475:0.05. LiOH raw material powder was added with a 3 wt % excess relative to the weight corresponding to LiOH at the above molar ratio. The heat treatment conditions were the same as in Example 1, except that the temperature for the main heat treatment was changed to 500° C. Thus, the negative electrode active material of Example 7 was produced.

### Comparative Example 1

The negative electrode active material of Comparative Example 1 was produced in the same manner as in Example 7, except that the temperature for the main heat treatment was changed to 400° C.

### Comparative Example 2

The negative electrode active material of Comparative Example 2 was produced in the same manner as in Example 2, except that the temperature for the main heat treatment was changed to 1,100° C. The negative electrode active material of Comparative Example 2 strongly adhered to the crucible due to melting and could not be removed from the crucible; therefore, evaluations such as composition analysis could not be performed.

### Comparative Example 3

Li₂CO₃, V₂O₅, and TiO₂ were prepared at a molar ratio of Li₂CO₃:V₂O₅:TiO₂=1.525:0.475:0.05. The excess amount of Li₂CO₃ was not added. The heat treatment conditions were the same as in Example 1, except that the temperature for the main heat treatment was changed to 800° C. Thus, the negative electrode active material of Comparative Example 3 was produced.

### Composition Analysis

For the negative electrode active materials of Examples 1 to 7 and Comparative Examples 1 and 3, “x” (Ti content) and “α” (Li content) in the composition formula (1) denoted as Li_{3+x+α}V₁₋ₓMₓO_{4+α/2} were measured by ICP optical emission spectrometry (PS3520VDDII manufactured by Hitachi High-Tech Science Corporation) and atomic absorption spectrometry (Z-2300 manufactured by Hitachi High-Technologies Corporation), respectively. The values of “x” and “α” for Examples 1 to 7 and Comparative Examples 1 and 3 are shown in Table 1.

### X-Ray Diffraction Measurement

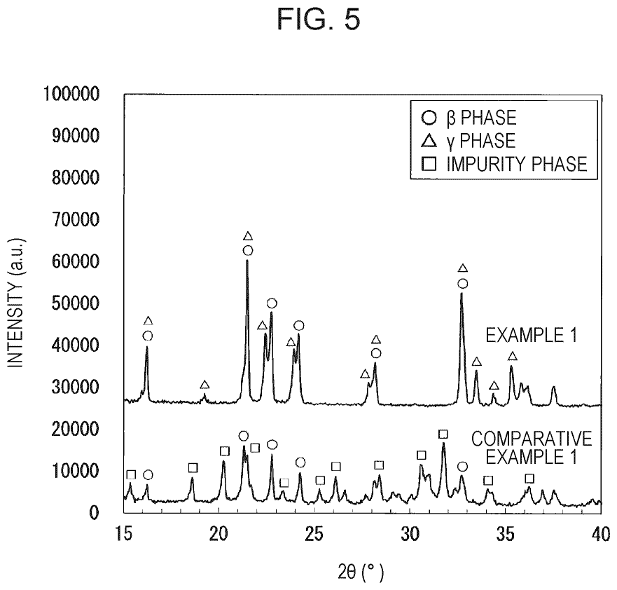

FIG. 5 shows the X-ray diffraction patterns of the negative electrode active materials of Example 1 and Comparative Example 1. The X-ray diffraction patterns were measured in the following manner.

The X-ray diffraction patterns of the negative electrode active materials of Example 1 and Comparative Example 1 were measured using an X-ray diffractometer (Rigaku Holdings Corporation, MiniFlex600) in a dry atmosphere with a dew point of less than or equal to −45° C. Cu-Kα radiation (wavelengths: 1.5405 Å and 1.5444 Å) was used as the X-ray source.

As shown in FIG. 5, the X-ray diffraction pattern obtained from the negative electrode active material of Example 1 exhibited both diffraction peaks assigned to the crystal planes of a β phase and diffraction peaks assigned to the crystal planes of a γ phase. That is, the negative electrode active material of Example 1 included both β and γ phases as crystal phases. As shown in FIG. 5, the X-ray diffraction pattern obtained from the negative electrode active material of Comparative Example 1 exhibited diffraction peaks assigned to the crystal planes of a β phase and diffraction peaks unassigned to any crystal planes of the β and γ phases. That is, the negative electrode active material of Comparative Example 1 included a β phase and impurities unassigned to the β phase as crystal phases.

As with Example 1 and Comparative Example 1, the negative electrode active materials of Examples 2 to 7 and Comparative Example 3 were also subjected to the measurement of the X-ray diffraction pattern. Each of the negative electrode active materials of Examples 2 to 5 and 7 included β and γ phases as crystal phases. The negative electrode active material of Example 6 included only a β phase as a crystal phase. The negative electrode active material of Comparative Example 3 included only a β phase as a crystal phase.

### Battery Fabrication

The negative electrode active materials of Examples 1 to 7 and Comparative Examples 1 and 3 and a solid electrolyte, Li₃PS₄, were prepared at a volume ratio of negative electrode active material:solid electrolyte=60:40 in an argon atmosphere with a dew point of less than or equal to −60° C. These materials were mixed in an agate mortar. Thus, the material mixtures for the negative electrodes of Examples 1 to 7 and Comparative Examples 1 and 3 were obtained.

The solid electrolyte Li₃PS₄ (80 mg) and the material mixture for the negative electrode (6.5 mg) were stacked in an insulating cylinder with an inner diameter of 9.5 mm to obtain a layered body. This layered body was pressurized at 360 MPa to form a solid electrolyte layer and a negative electrode. The solid electrolyte layer had a thickness of 500 μm.

Next, Li (thickness: 300 μm) was stacked onto the solid electrolyte layer. This layered body was pressurized at 80 MPa to form a positive electrode.

Next, stainless steel current collectors were attached to the positive and negative electrodes, and current collection leads were attached to the current collectors.

Finally, the interior of the insulating cylinder was sealed with an insulating ferrule to prevent the interior of the cylinder from exposure to the external atmosphere.

According to the above procedure, the batteries of Examples 1 to 7 and Comparative Examples 1 and 3 were fabricated.

### Charge-Discharge Test

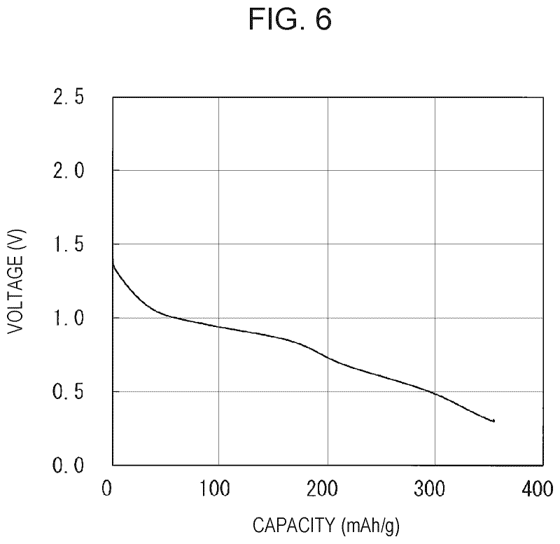

FIG. 6 is a graph of the initial discharge characteristics of the battery of Example 1. The horizontal axis represents discharge capacity. The vertical axis represents voltage. The results shown in FIG. 6 were obtained by measurement using the following method.

The battery of Example 1 was placed in a constant-temperature chamber maintained at 25° C.

The battery of Example 1 was discharged at a current rate of 0.1 C (10-hour rate) based on the theoretical capacity of the battery until the voltage reached 0.3 V. Next, the battery of Example 1 was charged at a current rate of 0.05 C until the voltage reached 2.5 V.

As with the battery of Example 1, the batteries of Examples 2 to 7 and Comparative Examples 1 and 3 were also subjected to the charge-discharge test. The discharge capacities of the batteries of Examples 1 to 7 and Comparative Examples 1 and 3 as measured in the charge-discharge test are shown in Table 1.

TABLE 1

| | | | | | Heat | Heat | | |
|---|---|---|---|---|---|---|---|---|
| | | | | | treatment | treatment | | Discharge |
| | Li raw | Li_{3+x+α}V₁₋ₓMₓO_{4+α/2} | | | temperature | time | Crystal | capacity |
| | material | M | x | α | (° C.) | (hours) | structure | (mAh/g) |
| Example 1 | Li₂CO₃ | Ti | 0.05 | 0.07 | 900 | 15 | Mixture of β | 354 |
| | | | | | | | and γ phases | |
| Example 2 | | | | 0.21 | 940 | 15 | Mixture of β | 307 |
| | | | | | | | and γ phases | |
| Example 3 | | | | 0.12 | 985 | 5 | Mixture of β | 298 |
| | | | | | | | and γ phases | |
| Example 4 | | | | 0.12 | 800 | 15 | Mixture of β | 355 |
| | | | | | | | and γ phases | |
| Example 5 | | | | 0.13 | 700 | 15 | Mixture of β | 367 |
| | | | | | | | and γ phases | |
| Example 6 | | | | 0.14 | 600 | 15 | Single β phase | 346 |
| Example 7 | LiOH | | | 0.17 | 500 | 15 | Mixture of β | 350 |
| | | | | | | | and γ phases | |
| Comparative | | | | 0.20 | 400 | 15 | β phase and | 205 |
| Example 1 | | | | | | | impurities | |
| Comparative | Li₂CO₃ | | | Not | 1100 | 5 | Not | Not |
| Example 2 | | | | measurable | | | measurable | measurable |
| Comparative | | | | 0.01 | 800 | 15 | Single β phase | 188 |
| Example 3 | | | | | | | | |

### Discussion

The results of Examples 1 to 7 show that each battery using a negative electrode containing a negative electrode active material produced through heat treatment at a temperature of more than 400° C. and less than 1,100° C. exhibited high discharge capacity.

The battery using the negative electrode active material of Comparative Example 1, which was produced through heat treatment at a temperature of 400° C., exhibited low discharge capacity. The results of Comparative Example 2 show that the negative electrode active material melted when the temperature for the main heat treatment was raised to as high as 1,100° C. The negative electrode active materials of Examples 1 to 5 and 7 included a mixture of β and γ phases. When the negative electrode active materials including a mixture of β and γ phases were used in batteries, the batteries tended to exhibit high discharge capacity.

As described above, a negative electrode active material produced by the method of the present disclosure exhibits high discharge capacity and is suitable for increasing battery capacity when used in the negative electrode of batteries.

The method for producing a negative electrode active material according to the present disclosure can be used for lithium-ion secondary batteries, for example.

What is claimed is:

1. A method for producing a negative electrode active material, the method comprising:
heat-treating a raw material mixture for the negative electrode active material at a temperature of more than 400° C. and less than 1,100° C.,
wherein the negative electrode active material has a composition represented by Li_{3+x+α}V₁₋ₓMₓO_{4+α/2},
wherein M is at least one selected from tetravalent semi-metal elements and tetravalent metal elements excluding V, and
wherein α and x satisfy 0.03≤α≤1.0 and 0≤x≤1.

2. The method for producing a negative electrode active material according to claim 1,
wherein α and x satisfy 0.07≤α≤0.21 and 0.01≤x≤0.19.

3. A method for producing a negative electrode active material, the method comprising:
heat-treating a raw material mixture for the negative electrode active material at a temperature of more than 400° C. and less than 1,100° C.,
wherein the negative electrode active material contains Li, V, M, and O,
wherein M is at least one selected from the group consisting of tetravalent semi-metal elements and tetravalent metal elements excluding V, and
wherein the negative electrode active material includes both β and γ phases as crystal phases.

4. The method for producing a negative electrode active material according to claim 1,
wherein the raw material mixture is heat-treated at a temperature of more than or equal to 450° C. and less than or equal to 1,000° C.

5. The method for producing a negative electrode active material according to claim 1,
wherein the raw material mixture is heat-treated at a temperature of more than or equal to 500° C. and less than or equal to 900° C.

6. The method for producing a negative electrode active material according to claim 1,
wherein the raw material mixture is a mixture containing a Li raw material containing Li and O, a V raw material containing V and O, and an M raw material containing M and O.

7. The method for producing a negative electrode active material according to claim 1,
wherein M includes Ti.

8. The method for producing a negative electrode active material according to claim 1,
wherein the raw material mixture is heat-treated for more than or equal to 5 hours.
